(19) United States
(12) Patent Application Publication
(10) Pub. No.: US 2023/0074396 A1
(43) Pub. Date: Mar. 9, 2023

(54) LENS CONTROL SYSTEM AND METHOD FOR COMPENSATING GRAVITY IMBALANCE

(71) Applicant: Carl Zeiss AG, Oberkochen (DE)

(72) Inventor: Charles Moon, Rochester, NY (US)

(21) Appl. No.: 17/467,143

(22) Filed: Sep. 3, 2021

(51) Int. Cl. H04N 5/232; H04N 17/00; G02B 7/02

(52) U.S. Cl. CPC H04N 5/23287; H04N 17/002; G02B 7/023; H04N 5/23258; G02B 7/021

(57) ABSTRACT

A lens control system and a method for compensating a disturbance force acting on a lens group of an optical assembly are provided. The optical assembly includes an actuator configured to move the lens group along an optical axis in response to an optical lens position command received from the camera controller. The lens control system further includes an optical assembly controller with a power driver configured to apply an electrical energy to the actuator to produce a force that acts on the lens group to move the lens group to a commanded position, a current sensor configured to measure a current flowing through the actuator in response to the electrical energy applied to the at least one actuator, and a position sensor configured to generate position information by measuring an actual position of the lens group.

### TECHNICAL FIELD

The disclosure relates to a control system and a method for compensating a disturbance force acting on an actuator causing a gravity imbalance, and in particular to a lens control system and a method for compensating a gravitational disturbance force acting on an actuator of a lens group of an optical assembly.

### BACKGROUND

Digital camera systems create two-dimensional images by collecting and geometrically controlling the spatial alignment of incoming light rays onto an array of image sensor picture elements (pixels). By changing exposure parameters such as aperture, focus, shutter speed, and International Organization for Standardization (ISO) film sensitivity, the captured image can be manipulated to fit an artistic expression.

Highly automated camera functions require the camera processors to precisely synchronize the movement of lens groups with the image acquisition. Lens control processors of such cameras utilize closed-loop control techniques based on linear lens positions of the lens groups and based on voice coil current measurements to smoothly move the lens groups to their target positions.

Camera processors may have inertial measurement unit (IMU) sensors which are provided to keep the camera display in an upright or horizontal position as the user rotates the camera body and the gravity angle changes.

U.S. Pat. No. 10,739,551 B1 describes techniques to compensate for changes in a depth of field of a camera caused by changes in orientation of the camera (e.g., tilt) and changes in the temperature of the camera. However, conventional control systems, such as the system described in U.S. Pat. No. 10,739,551 B1 do not track performance of position and velocity commands based on gravity information to optimize general performance of the lens control system.

Therefore, it has been a continuing need for improving the position and velocity command tracking performance of an optical system by using knowledge of the earth's gravitational force acting on an optical assembly to optimize the tuning of the closed-loop control system.

### SUMMARY

It is therefore an object of the present disclosure to improve an optical assembly position and velocity command tracking performance of a lens control system by compensating a disturbance force acting on at least one lens group of an optical assembly of the lens control system.

The object is achieved by adjusting closed-loop tuning parameters of an actuator of a lens group based on a pitch angle to compensate a disturbance force acting on the actuator.

According to an aspect of the disclosure, the pitch angle is obtained from an IMU. According to another aspect of the disclosure, the pitch angle is estimated by extracting a force acting on the actuator due to gravity from a commanded and measured voice coil current.

The lens control system for compensating the disturbance force acting on the at least one lens group of the optical assembly includes a camera controller. The optical assembly includes the at least one lens group on which the disturbance force acts and at least one actuator. The at least one lens group defines an optical axis and the at least one actuator is configured to move the at least one lens group along the optical axis in response to an optical lens position command received from the camera controller.

The lens control system further includes an optical assembly controller in communication with the camera controller. The optical assembly controller includes a power driver configured to apply an electrical energy to the at least one actuator to produce a force that acts on the at least one lens group to move the at least one lens group to a commanded position, a current sensor configured to measure a current flowing through the at least one actuator in response to the electrical energy applied to the at least one actuator, and a position sensor configured to generate position information by measuring an actual position of the at least one lens group.

According to an aspect of the disclosure, the optical assembly controller further includes a closed loop controller configured to determine a correct amount of the electrical energy required to move the at least one lens group to the commanded position based on gravity orientation information and the position information.

According to a further aspect of the disclosure, the camera controller includes an inertial measurement unit. The inertial measurement unit provides the gravity orientation information.

According to yet another aspect of the disclosure, the gravity orientation information can also be determined by extracting a component of an entirety of forces acting on the at least one actuator created by gravity without an inertial measurement unit. In other words, according to this aspect of the disclosure, the gravity orientation information is determined by the optical assembly controller without relying on information external to the optical assembly controller.

According to a further aspect of the disclosure, the entirety of forces is directly proportional to the current flowing through the at least one actuator. The disturbance force includes a gravitational force, and electrical and mechanical forces result from a change in the operating conditions.

According to an aspect of the disclosure, the change in the operating conditions includes a change in temperature and a change in a power source capacity. According to yet another aspect of the disclosure, the electrical energy includes a first component required to change the position of the at least one actuator to the commanded position, and a second component required to compensate the disturbance force. According to a further aspect of the disclosure, the at least one actuator includes a linear voice coil actuator.

The object of the disclosure is further achieved by a method for compensating a disturbance force acting on at least one lens group of an optical assembly, the at least one lens group defining an optical axis, the optical assembly further including at least one actuator configured to move the at least one lens group along the optical axis in response to an optical lens position command received from a camera controller, the method including applying an electrical energy to the at least one actuator to produce a force that acts on the at least one lens group to move the at least one lens group to a commanded position, measuring, by a current sensor, a current flowing through the at least one actuator in response to the electrical energy applied to the at least one actuator, and generating, by a position sensor, position information by measuring an actual position of the at least one lens group.

According to an aspect of the disclosure, the method further includes determining, by a closed loop controller, a correct amount of the electrical energy required to move the at least one lens group to the commanded position based on gravity orientation information and the position information.

According to yet another aspect of the disclosure, the method further includes determining the gravity orientation information by extracting a component of an entirety of forces acting on the at least one actuator created by gravity without an inertial measurement unit.

### BRIEF DESCRIPTION OF THE DRAWINGS

The invention will now be described with reference to the drawings wherein:

FIG. 1 shows a schematic illustration of a camera showing pitch, roll, and yaw axes of an optical assembly,

FIG. 2A shows a linear voice-coil actuator in a first position,

FIG. 2B shows the linear voice-coil actuator in a second position,

FIG. 3 shows a simplified block diagram of a high-performance digital camera,

FIG. 4A shows a simplified block diagram of a lens control system with a current loop and a position loop according to a first exemplary embodiment of the disclosure,

FIG. 4B shows a simplified block diagram of a lens control system with a position loop according to a second exemplary embodiment of the disclosure,

FIG. 5 shows a simplified block diagram of a lens control system with a current loop and a position loop according to a third exemplary embodiment of the disclosure,

FIG. 6 shows a schematic illustration of a voice coil lens actuator frequency response at different gravity orientations,

FIG. 7A shows a schematic illustration of a tracking performance in a first direction and with three different gravity orientations,

FIG. 7B shows a schematic illustration of a tracking performance in a second direction and with three different gravity orientations,

FIG. 8A shows a schematic illustration of a tracking performance in a first direction and with four different gravity orientations,

FIG. 8B shows a schematic illustration of a tracking performance in a second direction and with four different gravity orientations,

FIGS. 9A and 9B show force diagrams for a vertical-up position,

FIG. 9C shows a force diagram in a vertical-down position

FIG. 10A shows a voice coil gravity imbalance torque over tilt angle for a first lens group,

FIG. 10B shows a voice coil gravity imbalance torque over tilt angle for a second lens group, and

FIG. 11 shows a flowchart of a method for compensating a disturbance force acting on a lens group of an optical assembly according to an exemplary embodiment of the disclosure.

### DESCRIPTION OF EXEMPLARY EMBODIMENTS

Exemplary embodiments of the disclosure will be explained below with reference to the accompanying schematic figures. Features that coincide in their nature and/or function may in this case be provided with the same designations throughout the figures.

The terms “exhibit”, “have”, “comprise” or “include” or any grammatical deviations therefrom are used in a non-exclusive way. Accordingly, these terms can refer either to situations in which, besides the feature introduced by these terms, no further features are present, or to situations in which one or more further features are present. For example, the expression “A exhibits B”, “A has B”, “A comprises B” or “A includes B” may refer both to the situation in which no further element aside from B is provided in A (that is to say to a situation in which A is composed exclusively of B) and to the situation in which, in addition to B, one or more further elements are provided in A, for example element C, elements C and D, or even further elements.

Furthermore, the terms “at least one” and “one or more” and grammatical modifications of these terms or similar terms, if they are used in association with one or more elements or features and are intended to express the fact that the element or feature can be provided singly or multiply, in general are used only once, for example when the feature or element is introduced for the first time. When the feature or element is subsequently mentioned again, the corresponding term “at least one” or “one or more” is generally no longer used, without restriction of the possibility that the feature or element can be provided singly or multiply.

Also, the terms “preferably”, “in particular”, “by way of example” or similar terms are used in conjunction with optional features, without alternative embodiments thereby being restricted. In this regard, features introduced by these terms are optional features, and there is no intention to restrict the scope of protection of the claims, and in particular of the independent claims, by these features. In this regard, the invention, as will be recognized by a person of ordinary skill in the art, can also be carried out using other configurations. Similarly, features introduced by “in one embodiment of the invention” or “in one exemplary embodiment of the invention” are to be understood to be optional features, without this being intended to restrict alternative refinements or the scope of protection of the independent claims. Furthermore, all possibilities of combining the features introduced by these introductory expressions with other features, whether optional or non-optional features, are intended to remain unaffected by said introductory expressions.

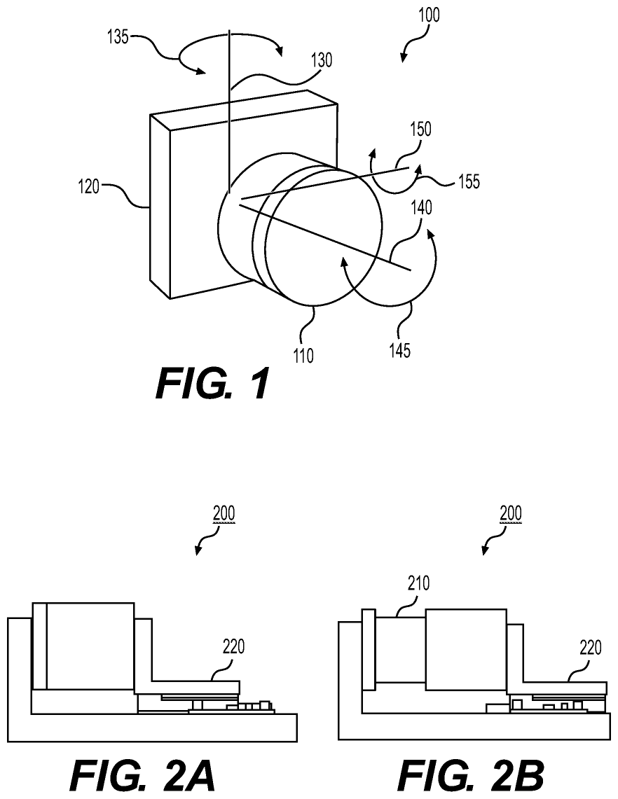

FIG. 1 shows a schematic illustration of a camera 100 with an optical assembly 110 with inertial axes, namely the yaw axis 130, the roll axis 140, and the pitch axis 150, relative to the camera body 120 and the optical assembly 110 around which the camera body 120 together with the optical assembly 110 can be rotated. As shown in FIG. 1, the roll axis 140 extends through the center on the optical axis of the optical assembly 110 and orthogonal to the yaw axis 130 and the pitch axis 150. Corresponding to the yaw axis 130, the roll axis 140, and the pitch axis 150, FIG. 1 shows yaw angle 135, roll angle 145, and pitch angle 155.

Changes in the pitch angle 155 are orthogonal to changes in the yaw angle 135 and the roll angle 155, and result in the optical assembly 110 tilting up or down. A rotation about the yaw axis 130 is a rotation of a plane defined by the pitch axis 150 and the roll axis 140 and is also orthogonal to the pitch axis 150 and the roll axis 140.

FIG. 2A shows a linear voice coil actuator 200 in a first position, and FIG. 2B shows the linear voice coil actuator 200 in a second position. The optical assembly 110 includes at least one lens group (not shown) and a plurality of linear voice coil actuators 200 configured to move the at least one lens group along the roll axis 140 which is the optical axis of the optical assembly 110.

Linear voice coil actuators 200 are a type of direct drive mechanism that provides extremely precise positioning of a lens group over small displacements. Like linear motors, linear voice coil actuators 200 work on the principle of a permanent magnet field and a coil winding. When a current is applied to the coil 210, a force is generated (known as the Lorentz force). Operationally, the force produced by a voice coil causes the moving part 220 or linear bearing to travel, e.g., from a first position shown in FIG. 2A to a second position shown in FIG. 2B, which in turn pushes or pulls the load, e.g., a lens group (not shown) arranged on the moving part 220 in a straight line.

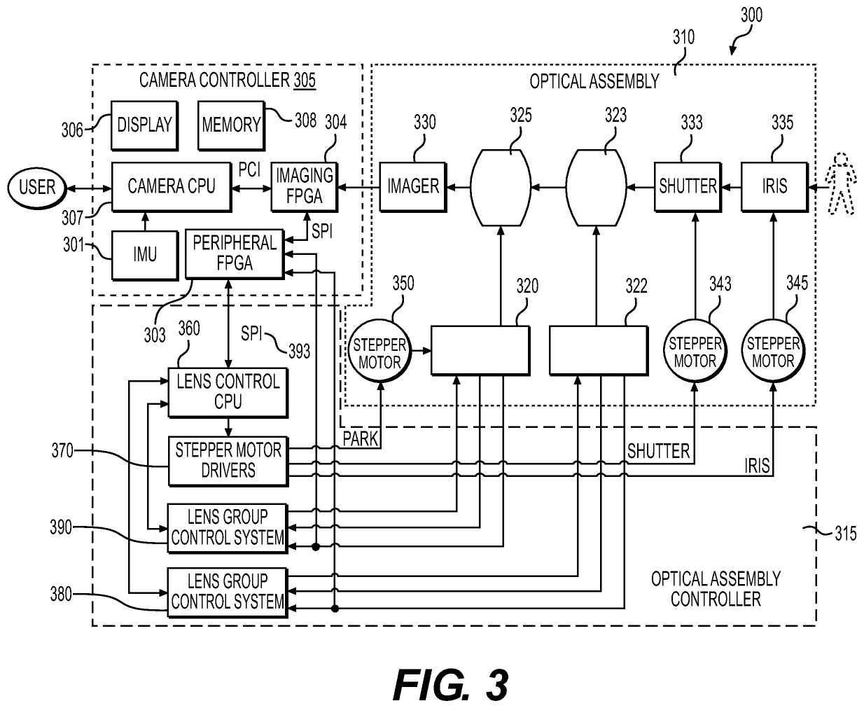

FIG. 3 shows a simplified block diagram of a lens control system 300 of a high-performance optical device. The high-performance optical device can be, e.g., a hand-held device or a digital camera. The lens control system 300 includes a camera controller 305, an optical assembly 310, and an optical assembly controller 315. As shown in FIG. 3, the camera controller 305 includes a display 306, a camera central processing unit (CPU) 307 or camera processor, a memory 308, a peripheral field-programmable gate array (FPGA) 303 and an imaging FPGA 304.

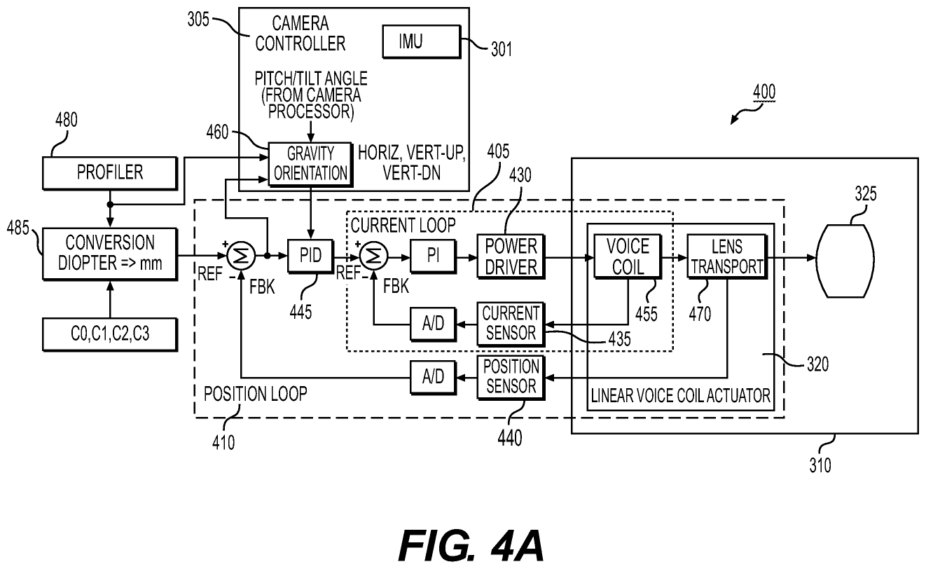

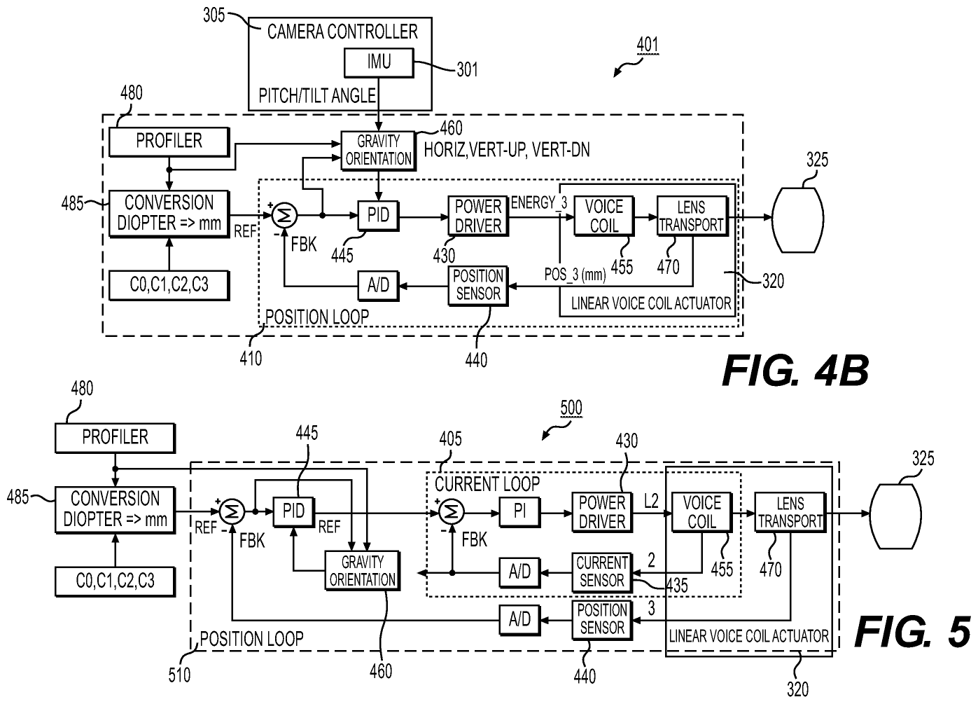

As shown in FIG. 3, the optical assembly 310 includes a first lens group 323 and a second lens group 325 defining an optical axis (not shown). Each of the first and the second lens groups 323, 325 are movable by respective actuators 320, 322 and can be independently positioned along the linear optical axis. The actuators can be linear voice coil actuators. Using closed-loop position control, such as position loop 410 shown in FIGS. 4A and 4B, the force required to move the lens to the desired position is determined by tuned filtering of the error produced by subtracting the commanded from the actual position, then amplifying and applying electrical energy to the voice coil impedance which produces an electrical current to move the lens to the desired position.

The optical assembly 310 further includes imager 330, shutter 333, and iris 335. Shutter 333 is operated by stepper motor 343 and iris 335 is operated by stepper motor 345. Further, optical assembly 310 includes 350 to place the second lens group 325 in a park position. As also shown in FIG. 3, the optical assembly controller 315 includes lens control CPU 360, stepper motor drivers 370, a first lens group control system 380, and a second lens control system 380.

The optical assembly controller 315 uses closed-loop control of a linear lens position and a voice coil current to smoothly move either lens group. The camera controller 305 also includes an IMU sensor 310 which is conventionally used to maintain the image shown on display 306 in an upright position as the user rotates the camera body 120.

The first and second lens groups 323, 325 can be independently positioned along the optical axis which corresponds to the roll axis 140. The optical assembly controller 315 receives optical lens position commands from the camera controller 305 via Serial Peripheral Interface (SPI) 393 for each lens group in units of diopters and converts the optical lens position commands to linear lens position commands. Using closed-loop position control of each lens group 323, 325, an electrical current is produced to control the force necessary to move the voice coil with linear bearings 220 that support the lens groups 323, 325 to the desired position measured by a sensor.

Turning now to FIG. 4A which shows a simplified block diagram of a lens control system 400 with a current loop 405 and a position loop 410 controlled by the closed loop controller 445 according to a first exemplary embodiment of the disclosure. The closed loop controller 445 can be a PID controller.

As shown in FIG. 4A, the position loop 410 includes the closed loop controller 445, the power driver 430, the linear voice coil actuator 320, and the position sensor 440. The linear voice coil actuator 320 includes voice coil 455 and lens transport 470. The current loop 405 is formed by the power driver 430, the voice coil 455 and the current sensor 435. Furthermore, the lens control system 400 includes profiler 480 and conversion unit 485.

A linear voice-coil actuator 320 is a type of direct-drive linear motor. The current flowing through the coil assembly 210 interacts with the permanent magnetic field and generates a force vector (torque) perpendicular to the direction of the current, along the lens transport axis of motion which corresponds to the roll axis 140. Voice coil motors are generally brushless and do not utilize commutation. Their structural stability can support high positioning resolutions.

The linear voice-coil actuator 320, 322 has a non-commutated motor construction which increases reliability. The direct coupling of the linear voice-coil actuator 320, 322 to the load, i.e., the lens group 323, 325 allows for fast acceleration/deceleration such that very high speeds and accelerations can be easily achieved. Closed-loop control of the voice coil current by the current loop 405, which generates a torque or force, overcomes the bandwidth limitations of voice coil electrical resistance and inductance and improves load disturbance rejection. In other words, the current loop 405 normalizes all of the torque disturbances, i.e., the disturbance forces acting on the lens group 323, 325 and/or on the linear voice-coil actuator 320, 322. This includes a torque disturbance or disturbance force, or a component thereof, due to gravity.

Although the current loop 405 may normalize torque disturbances in any gravity orientation, it has been shown that normalization of torque disturbances in a horizontal gravity orientation, i.e., when the optical assembly 110 is rotated around the pitch axis 150, significantly improves operation of the camera functions, e.g., the zoom function. Thus, by dynamically changing the tuning of the control loops based on the gravity orientation information 460, stability of the system can be improved.

Closed-loop control of the lens transport position by the position loop 410 is needed to overcome static and dynamic frictional and inertial loads.

The position loop 410 includes closed loop controller 445. The closed loop controller 445 is configured to determine a correct amount of the electrical energy required to move the at least one lens group 325 to the commanded position based on gravity orientation information 460 and position information generated by the position sensor 440. As shown in FIG. 4A, the camera controller 305 includes an inertial measurement unit 301. The inertial measurement unit 301 provides the gravity orientation information 460.

The position loop 410 is called every 25 μsec when a timer interrupt occurs. It takes 6 passes for all of the calculations to generate a new current and output to each actuator 455.

On the 1^{st} pass, the actual lens actuator positions are read via an analog/digital (A/D) converter and a position trajectory for each lens group 323, 325 (in the optical diopter space) is generated. This makes it possible for both lens groups 323, 325 to synchronously maintain a contrast or phase focus mode. On the 2^{nd} pass, the lens positions are converted from millimeters (mm) to diopters. On the 3^{rd} pass, the commanded position of the first of two lens groups 323 is subtracted from the actual (feedback) position and the error is multiplied by the PID loop compensation. The output is converted to a duty cycle and applied to the actuator 322.

On the 4^{th} pass, a commanded position of the second lens group 325 is subtracted from the actual (feedback) position and the error is multiplied by the PID loop compensation. The output is converted to a duty cycle and applied to the actuator 320. Nothing happens on the 5^{th} pass. On the 6^{th} pass, the phase counter is reset so the entire cycle can be repeated.

On the 3^{rd} pass, the current gravity orientation angle is compared to a threshold which determines if horizontal, vertical up, or vertical down tuning of the first lens group 323 should be applied. On the 4^{th} pass, the current gravity orientation angle is compared to a threshold which determines if horizontal, vertical up, or vertical down tuning of the second lens group 325 should be applied.

As discussed above, as the camera body 100 and the optical assembly 110 are physically tilted up or down about the pitch axis 150, a disturbance force acts upon the lens actuator 320, 322 and the lens group 323, 325 due to the earth's gravitational field. The disturbance force includes a gravitational force, and electrical and mechanical forces resulting from a change in operating conditions. More significantly, it has been determined that the disturbance force differs substantially depending on the gravity orientation of the optical assembly 110. When the optical assembly 110 is in a straight up position (i.e., the pitch angle 155 is at an angle Φ=90.0 degrees), the force to slide or move the lens group 325 is maximum in the direction towards the imager 330. This maximum equals the sliding mass times the acceleration due to gravity. Without any counter force from the voice coil 455, the lens group 325 will side to the end nearest the imager 330.

As the pitch angle 155 decreases towards a horizontal position (pitch angle Φ=0.0 degrees), the force to slide the lens group 325 decreases by sin(Φ). The lens stops moving when this force is less than the frictional force to slide the lens.

In the horizontal position (pitch angle Φ=0.0 degrees), there is no force to slide the lens group.

As the pitch angle 155 decreases towards a straight down position (pitch angle Φ=−90.0 degrees), the force to slide the lens group increases by sin(Φ). The lens group starts moving when this force is larger than the frictional force to slide the lens group. Without any counter force from the voice coil, the lens group will slide to the end farthest from the imager 330.

In the straight down position (pitch angle Φ=−90.0 degrees), the force to slide the lens group is maximum in the direction away from the imager 330. Thus, the lens control system 400 improves the optical assembly position and velocity command tracking performance by using the camera's pitch angle 155, obtained from the IMU 310 to adjust the closed-loop tuning parameters of the lens group 323 and lens group 325 linear voice coil actuator of actuators 320 and 322, respectively. This is a new utilization of IMU 310 sensor measurements which, as discussed above, are traditionally only used to keep the camera display horizontal as the gravity angle changes.

This is in particular different from the related art because knowledge of camera pitch angle 155 for tuning enables the same camera performance independent of gravity orientation. In other words, “best” closed-loop actuator tracking performance is realized when control loop tuning parameters adjust the actuator system frequency response to increase low frequency gain and bandwidth while maintaining adequate stability margins. Since a torque disturbance changes the frequency response and changing the gravity orientation of a portable camera causes a torque disturbance, fixed tuning parameters will not yield the same performance at different gravity orientations.

Using pitch angle 155, commanded position, velocity and servo error measurements to dynamically adjust tuning parameters ensures stability margins are maintained. By applying thresholds to the measured pitch angles which correspond to significant changes in the frequency response, simple efficient tuning adjustments can normalization tracking performance over a wide range of pitch values.

In addition, there is no need to dynamically stabilize the camera movement. Only the pitch information is needed. Roll angle 145 and yaw angle 135 have no effect on the control system because their forces are orthogonal to the optical assembly movement. Thus, the lens control system 400 is configured to dynamically select and transition to optimized tuning parameters as the system undergoes gravity orientation changes.

FIG. 4B shows a simplified block diagram of a lens control system 401 with a position loop according to a second exemplary embodiment of the disclosure. The exemplary embodiment shown in FIG. 4B is different from the exemplary embodiment shown in FIG. 4A in that it does not include a current loop 405. Instead, only position loop 410 is present. As shown in FIG. 4B, power driver 430 provides Energy_3 to voice coil 455 which moves lens group 325 via lens transport 470. Position sensor 440 measures the position POS_3 in millimeters (mm) of the lens group 325 and loops this information back to closed loop controller 445.

FIG. 5 shows a simplified block diagram of a lens control system 500 with a current loop 405 and a position loop 510 controlled by the closed loop controller 445 according to a third exemplary embodiment of the disclosure.

The third exemplary embodiment shown in FIG. 5 differs from the first exemplary embodiment shown in FIG. 4 in that the gravity orientation information 460 is determined by extracting a component of an entirety of forces acting on the actuator 320 created by gravity without an inertial measurement unit or any other source outside the position loop 510. In other words, the lens control system 500 system improves the optical assembly position and velocity command tracking performance by using the camera pitch angle 155, estimated by extracting the force due to gravity from the commanded and measured voice coil current, to adjust the closed-loop tuning parameters of the lens group 323 and lens group 325 linear voice coil actuator of actuators 320 and 322, respectively.

Thus, unlike in the first exemplary embodiment shown in FIG. 4, an IMU measurement of camera tilt/pitch is not needed. The pitch angle 155 can be estimated from knowing the commanded position and velocity dynamics and the steady state servo error.

All of the information needed to extract the gravity orientation from the voice coil current is locally available to the control system. By using commanded position, velocity and servo error measurements, tuning parameters can be dynamically adjusted to ensures stability margins are maintained.

By applying thresholds to the measured pitch angles 155 which correspond to significant changes in the frequency response, simple efficient tuning adjustments can normalization tracking performance over a wide range of pitch values.

As a result, there is no need to dynamically stabilize the camera movement which makes high-quality performance of the automatic zoom function, for example, possible. Only the pitch information is needed fort this control operation. Roll and Yaw have no effect on the control system because their forces are orthogonal to the optical assembly movement.

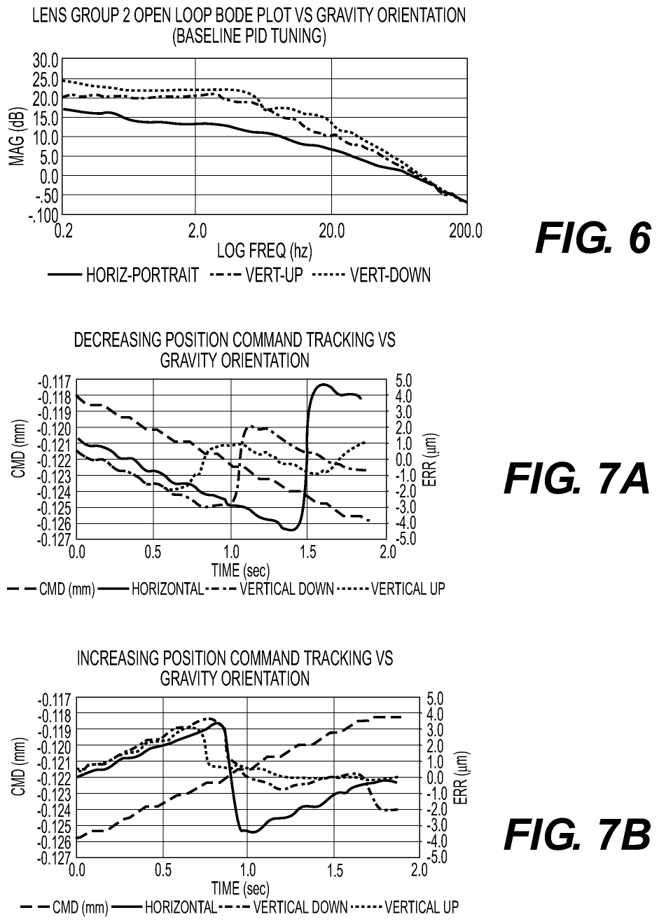

Turning now to FIG. 6 which shows a schematic illustration of a frequency response of voice coil actuator 320 at different gravity orientations. More specifically, FIG. 6 shows a measured closed-loop frequency response of one of the lens groups 323, 325 for horizontal (Φ=0 degrees), vertical-up (Φ=90 degrees), and vertical-down (Φ=−90 degrees) orientations.

The frequency response graphs show that the magnitude of the closed-loop tracking response below 40 Hz for horizontal orientation has the lowest gain and results in the worst lens positioning performance.

FIG. 7A shows a schematic illustration of a tracking performance of lens group 323 in a first direction and with three different gravity orientations, and FIG. 7B shows a schematic illustration of a tracking performance of lens group 323 in a second direction and with three different gravity orientations. The tracking performance is measured for the same baseline tuning regardless of gravity orientation. The position command CMD scaling is shown on the left side of the graph (mm) and the scaling for the tracking error ERR for the baseline, good, better, and best tuning on right (μm). The horizontal tracking is noticeably worse than either the vertical up or down tracking because the frequency response has lower gain below 0 dB, as shown above in FIG. 6.

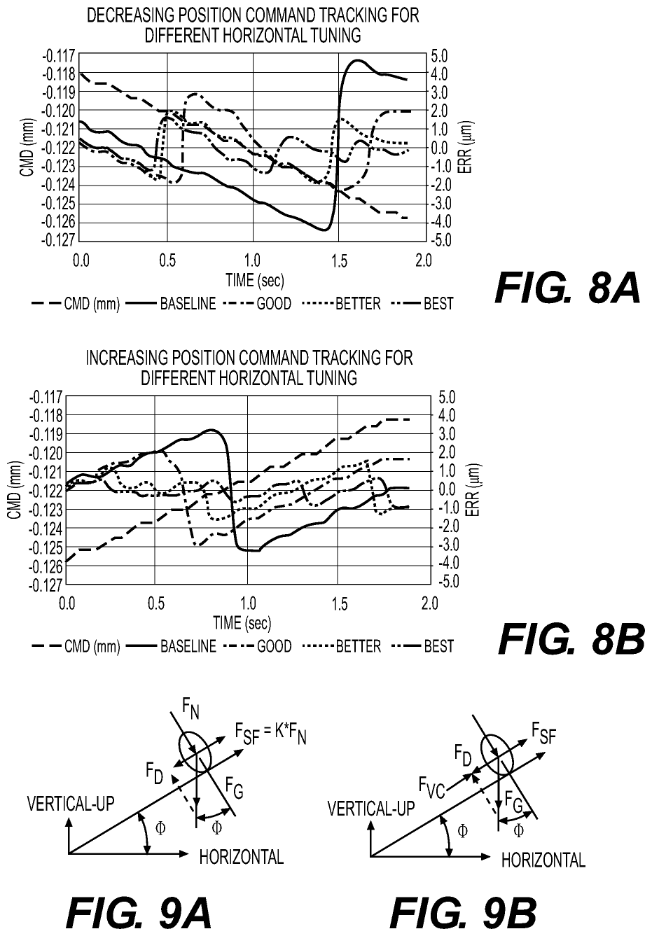

FIGS. 8A and 8B show the tracking performance for horizontal gravity orientations with 4 different sets of tuning. Again, the position command CMD scaling is shown on the left side of the graph (mm) and the scaling for the tracking error for the baseline, good, better, and best tuning on right (μm).

As shown in FIGS. 8A and 8B, the mechanics of linear actuators produce the poorest low frequency response in the horizontal orientation (˜12 dB lower between 5-20 Hz which is ˜4x). Without knowledge of the camera pitch angle 155, the same control loop tuning parameters would need to be used for all gravity orientations and the since most photographs are taken in near the horizontal orientation, this would result in a bad performance.

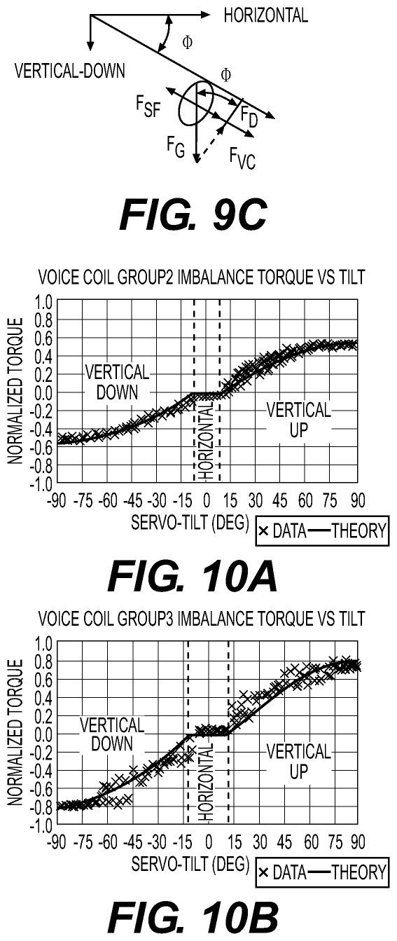

Turning now to FIGS. 9A to 9C in which FIGS. 9A and 9B show force diagrams for a vertical-up position, and FIG. 9C shows a force diagram in a vertical-down position. Generally, the lens groups 323, 325 are subject to the same forces as an object placed on a tilted surface. If the optical assembly 110, 310 is perpendicular to the earth's gravitational field, the lens groups 323, 325 stay in place because the zero gravitational force trying to cause the lens group to slide is less than the static friction keeping the lens group in place. As the angle of inclination is increased, this gravitational force increases to a maximum value, and the lens group 323, 325 accelerates because of this disturbance force of gravity.

As shown in FIGS. 9A and 9B, the forces related to the acceleration due to gravity of the lens group 323, 325 actuated by the voice coil 455 as it tilts up and down is a function of the angle of the mechanical optical axis relative to gravity and static friction of the bearing. F_{G} is the acceleration force on the optical assembly 110, 310 due to gravity {9.81 meters/sec2}. F_{VC} is the closed-loop force applied to the linear actuator 320 resulting from a positive current. A negative current produces a force in the opposite direction. F_{N} is the force of the optical assembly 110, 310 normal to the linear bearing. F_{SF} is the linear bearing static frictional force (which is the product of the coefficient of friction K and F_{N}).

Changes in gravity orientation result in deterministic mechanical imbalance forces or disturbance forces in the lens control system 300.

Using Newton's second law of motion, all forces on the center of mass of the optical assembly 110, 310 acting along the optical axis under the influence of gravity can be calculated:

F_{D}=F_{G}*SIN(Φ)=M*A*SIN(Φ),

wherein M is the lens group mass/weight, A is the acceleration due to gravity which is 9.8 meters/sec², and Φ is the tilt angle between the mechanical optical axis and horizontal plane normal to gravity.

In the absence of any force produced by the voice coil (F_{VC}), at a pitch angle 155 of Φ=0 degrees, (horizontal position) static friction keeps the lens from moving.

F_{D}=F_{G}*SIN(0)=0<F_{SF}

As the pitch angle 155 Φ increases towards 90 degrees (vertical-UP), at same angle Φ=Φ_{SLIDE}, the static bearing force (F_{SF}) is exceeded by the force on the optical assembly 110, 310 due to acceleration by gravity along the axis of movement (F_{D}) and the lens group 323, 325 starts to slide.

F_{D}=M*A*SIN(Φ_{SLIDE})>F_{SF}

For the closed-loop control system to position the lens group in the desired position, a restoring force is needed:

F_{VCclosed-loop}=F_{D}−F_{SF}

Assuming the coefficient of friction is the same, as the pitch angle Φ decreases from horizontal towards −90 degrees (vertical-DOWN), at tilt angle Φ=−Φ_{SLIDE}, the static bearing force (F_{SF}) is again exceeded by the force on the lens assembly due to acceleration by gravity along the axis of movement (F_{D}) and again the lens starts to slide, as shown in FIG. 9C.

In the vertical-down position shown in FIG. 9C, the voice coil restoring force (F_{VC}) needs to operate in the opposite direction. Therefore, the polarity of the current is reversed.

−F_{VCclosed-loop}=F_{D}−F_{SF}

FIGS. 10A and 10B show the measured unbalance torques vs. pitch angle 155 against the theoretical values for the voice coils for a Group2 and a Group3. Because Group3 (lens group 325) was 35% heavier, its holding friction is a little more than Group2 (lens group 323) and its normalized current is 35% higher.

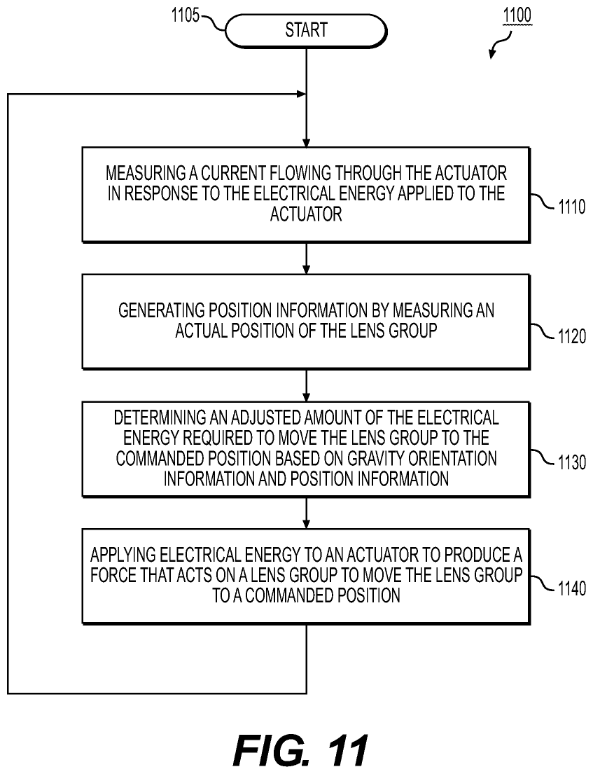

FIG. 11 shows a method 1100 for compensating a disturbance force acting on at least one lens group 325 of an optical assembly 310 when the at least one lens group 325 is moved according to an exemplary embodiment. The method starts at step 1105. At step 1110, a current flowing through the actuator 455 in response to the electrical energy applied to the actuator 455 is measured. The method continues to step 1120, at which position information is generated by measuring an actual position of the lens group 323, 325 by position sensor 440. At step 1130, an adjusted amount of the electrical energy required to move the lens group to the commanded position is determined based on gravity orientation information 460 and position information generated by the position sensor 440. The method continues to step 1140 at which electrical energy is applied to the actuator 455 to produce a force that acts on the lens group 323, 325 to move the lens group 323, 325 to a commanded position. After completing step 1140, the method starts again at step 1110.

It is understood that the foregoing description is that of the exemplary embodiments of the invention and that various changes and modifications may be made thereto without departing from the spirit and scope of the invention as defined in the appended claims.

### LIST OF REFERENCE NUMERALS

100 camera
110 optical assembly
120 camera body
130 yaw axis
135 yaw angle
140 roll axis
145 roll angle
150 pitch axis
155 pitch angle
200 linear voice coil actuator
210 coil
220 moving part
300 lens control system
301 inertial measurement unit
304 imaging FPGA
305 camera controller
306 display
308 memory
310 optical assembly
315 optical assembly controller
320 actuator
322 actuator
323 first lens group
325 second lens group
330 imager
333 shutter
335 iris
343 stepper motor
345 stepper motor
360 lens control CPU
370 stepper motor drivers
380 first lens group control system
400 lens control system
401 lens control system
405 current loop
410 position loop
430 power driver
435 current sensor
440 position sensor
445 closed loop controller
455 voice coil
460 gravity orientation information
470 lens transport
500 lens control system
510 position loop
1100 method
1105 step
1110 step
1120 step
1130 step
1140 step

What is claimed is:

1. A lens control system for compensating a disturbance force acting on at least one lens group of an optical assembly when the at least one lens group is moved, the lens control system comprising:
a camera controller;
the optical assembly including the at least one lens group on which the disturbance force acts and at least one actuator, the at least one lens group defining an optical axis and the at least one actuator being configured to move the at least one lens group along the optical axis in response to an optical lens position command received from the camera controller; and
an optical assembly controller in communication with the camera controller, the optical assembly controller including:
a power driver configured to apply an electrical energy to the at least one actuator to produce a force that acts on the at least one lens group to move the at least one lens group to a commanded position;
a current sensor configured to measure a current flowing through the at least one actuator in response to the electrical energy applied to the at least one actuator; and
a position sensor configured to generate position information by measuring an actual position of the at least one lens group.

2. The lens control system of claim 1, wherein the optical assembly controller further includes:
a closed loop controller configured to determine a correct amount of the electrical energy required to move the at least one lens group to the commanded position based on gravity orientation information and the position information.

3. The lens control system of claim 2, wherein the camera controller includes an inertial measurement unit, and
wherein the inertial measurement unit provides the gravity orientation information.

4. The lens control system of claim 2, wherein the gravity orientation information is determined by extracting a component of an entirety of forces acting on the at least one actuator created by gravity without an inertial measurement unit.

5. The lens control system of claim 4, wherein the entirety of forces is directly proportional to the current flowing through the at least one actuator.

6. The lens control system of claim 1, wherein the disturbance force includes a gravitational force, and electrical and mechanical forces resulting from a change in operating conditions.

7. The lens control system of claim 6, wherein the change in the operating conditions includes a change in temperature and a change in a power source capacity.

8. The lens control system of claim 1, wherein the electrical energy includes:
a first component required to change the position of the at least one actuator to the commanded position; and
a second component required to compensate the disturbance force.

9. The lens control system of claim 1, wherein the at least one actuator includes a linear voice coil actuator.

10. A method for compensating a disturbance force acting on at least one lens group of an optical assembly when the at least one lens group is moved, the at least one lens group defining an optical axis, the optical assembly further including at least one actuator configured to move the at least one lens group along the optical axis in response to an optical lens position command received from a camera controller, the method comprising:
applying an electrical energy to the at least one actuator to produce a force that acts on the at least one lens group to move the at least one lens group to a commanded position;
measuring, by a current sensor, a current flowing through the at least one actuator in response to the electrical energy applied to the at least one actuator; and
generating, by a position sensor, position information by measuring an actual position of the at least one lens group.

11. The method of claim 10, further comprising:
determining, by a closed loop controller, an adjusted amount of the electrical energy required to move the at least one lens group to the commanded position based on gravity orientation information and the position information, and
applying the adjusted amount of the electrical energy to the at least one actuator.

12. The method of claim 11, wherein the camera controller includes an inertial measurement unit, and
wherein the inertial measurement unit provides the gravity orientation information.

13. The method of claim 11, further comprising:
determining the gravity orientation information by extracting a component of an entirety of forces acting on the at least one actuator created by gravity without an inertial measurement unit.

14. The method of claim 13, wherein the entirety of forces is directly proportional to the current flowing through the at least one actuator.

15. The method of claim 10, wherein the disturbance force includes a gravitational force, and electrical and mechanical forces resulting from a change in operating conditions.

16. The method of claim 15, wherein the change in the operating conditions includes a change in temperature and a change in a power source capacity.

17. The method of claim 10, wherein the electrical energy includes:
a first component required to change the position of the at least one actuator to the commanded position; and
a second component required to compensate the disturbance force.

18. The method of claim 10, wherein the at least one actuator includes a linear voice coil actuator.
